(19) United States
(12) Patent Application Publication
(10) Pub. No.: US 2018/0016809 A1
(43) Pub. Date: Jan. 18, 2018

(54) Retractable Fence Assembly

(71) Applicant: Patrick Hyland, Fort Myers, FL (US)

(72) Inventor: Patrick Hyland, Fort Myers, FL (US)

(21) Appl. No.: 15/212,508

(22) Filed: Jul. 18, 2016

(51) Int. Cl. E04H 17/00; E04H 17/02; E04H 17/14; E06B 11/00

(52) U.S. Cl. CPC E04H 17/00; E06B 11/00; E04H 17/02; E04H 17/14

(57) ABSTRACT

A retractable fence assembly includes a plurality of lifting units. Each of the lifting units is sunk into a support surface. Each of the lifting units is selectively positioned in a deployed position to extend upwardly from the support surface. Each of the lifting units is selectively positioned in a stored position to be stored beneath the support surface. A fencing unit is operationally coupled to each of the lifting units. Each of the lifting units selectively positions the fencing unit in the deployed position to surround an area. Each of the lifting units selectively positions the fencing unit in the stored position. Thus, the fencing unit is positioned in a trench in the support surface thereby facilitating the fencing unit to be concealed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKSUPPORT SURFACE OF THE INVENTION

### (1) Field of the Invention

### (2) Description of Related Art Including Information Disclosed Under 37 CFR 1.97 and 1.98

The disclosure and prior art relates to fence devices and more particularly pertains to a new fence device for selectively storing a fence in a trench.

### BRIEF SUMMARY OF THE INVENTION

An embodiment of the disclosure meets the needs presented above by generally comprising a plurality of lifting units. Each of the lifting units is sunk into a support surface. Each of the lifting units is selectively positioned in a deployed position to extend upwardly from the support surface. Each of the lifting units is selectively positioned in a stored position to be stored beneath the support surface. A fencing unit is operationally coupled to each of the lifting units. Each of the lifting units selectively positions the fencing unit in the deployed position to surround an area. Each of the lifting units selectively positions the fencing unit in the stored position. Thus, the fencing unit is positioned in a trench in the support surface thereby facilitating the fencing unit to be concealed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a retractable fence assembly according to an embodiment of the disclosure.

FIG. 2 is a front perspective view of an embodiment of the disclosure.

FIG. 3 is a cross sectional view taken along line 3-3 of FIG. 1 of an embodiment of the disclosure in a deployed position.

FIG. 4 is a cross sectional view taken along line 3-3 of figured 1 of an embodiment of the disclosure in a stored position.

FIG. 5 is a cross sectional view taken along line 5-5 of FIG. 2 of an embodiment of the disclosure.

FIG. 6 is a schematic view of an embodiment of the disclosure.

### DETAILED DESCRIPTION OF THE INVENTION

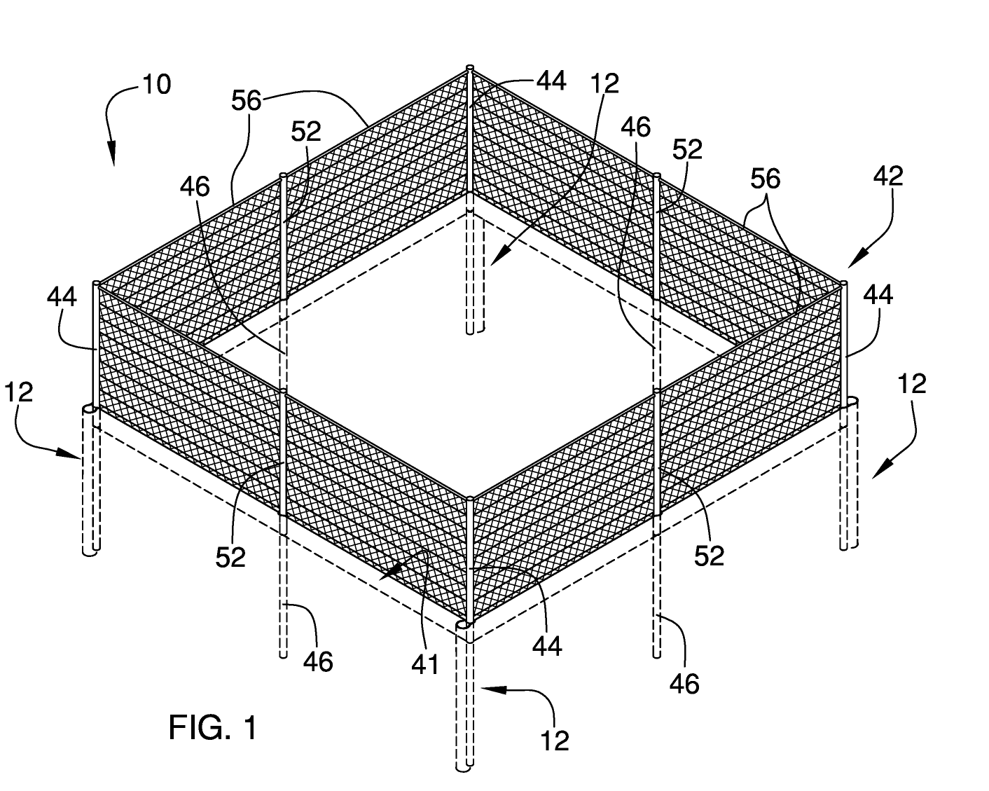

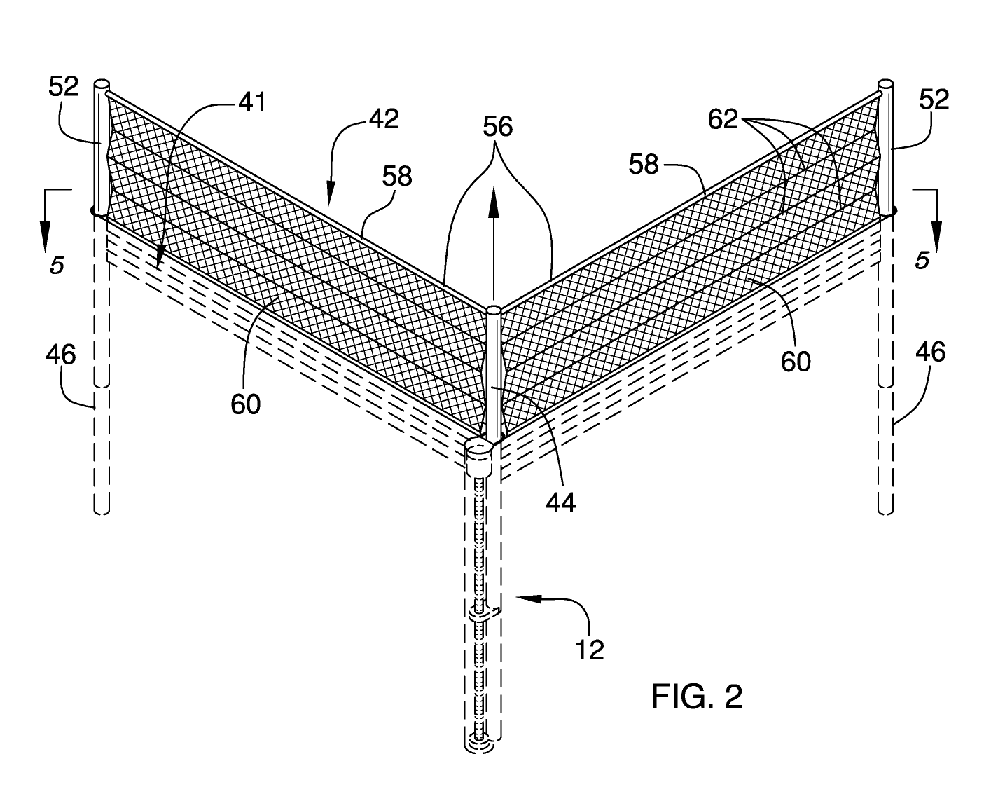

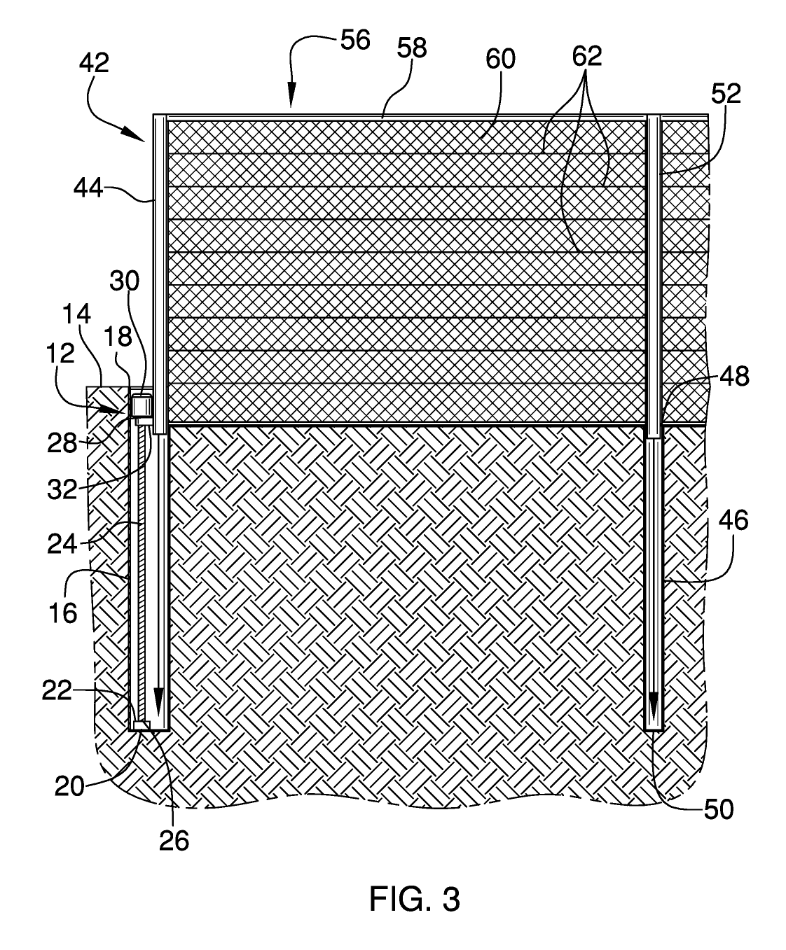

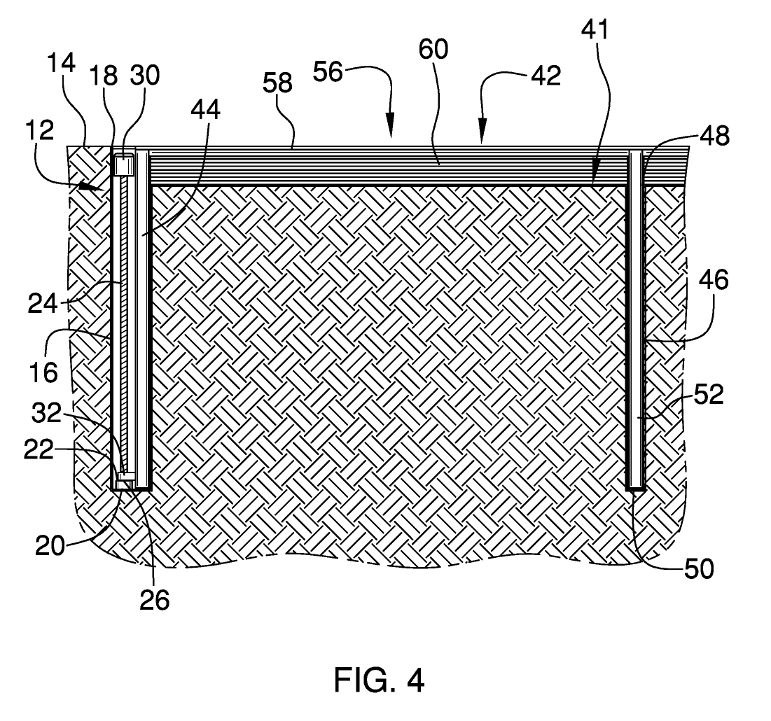

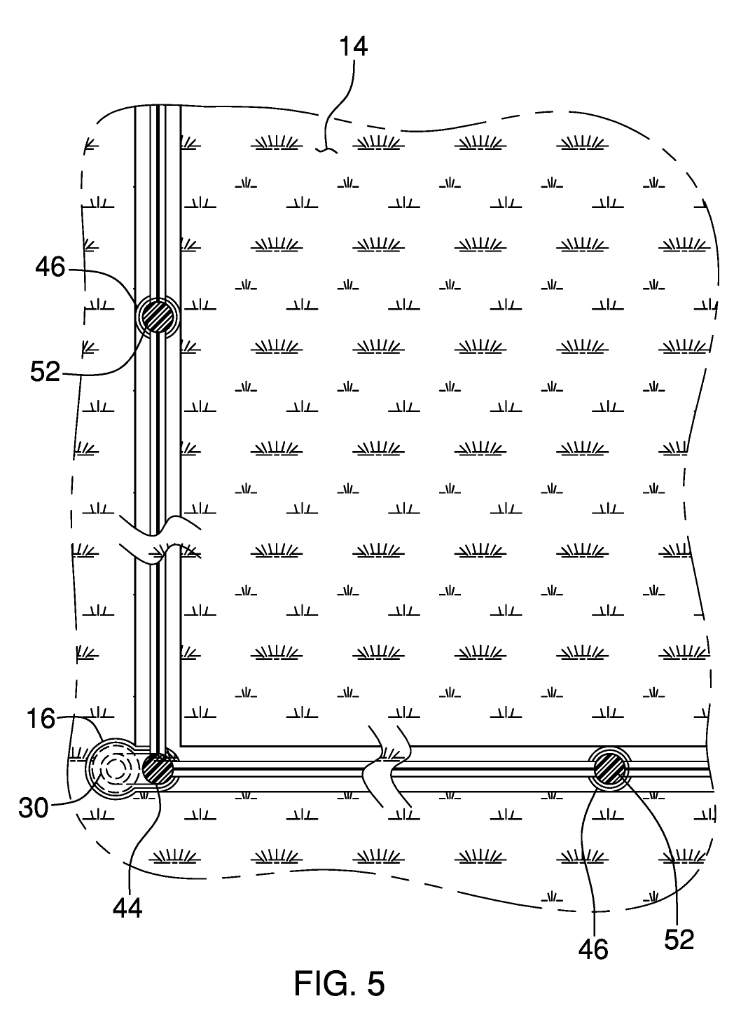

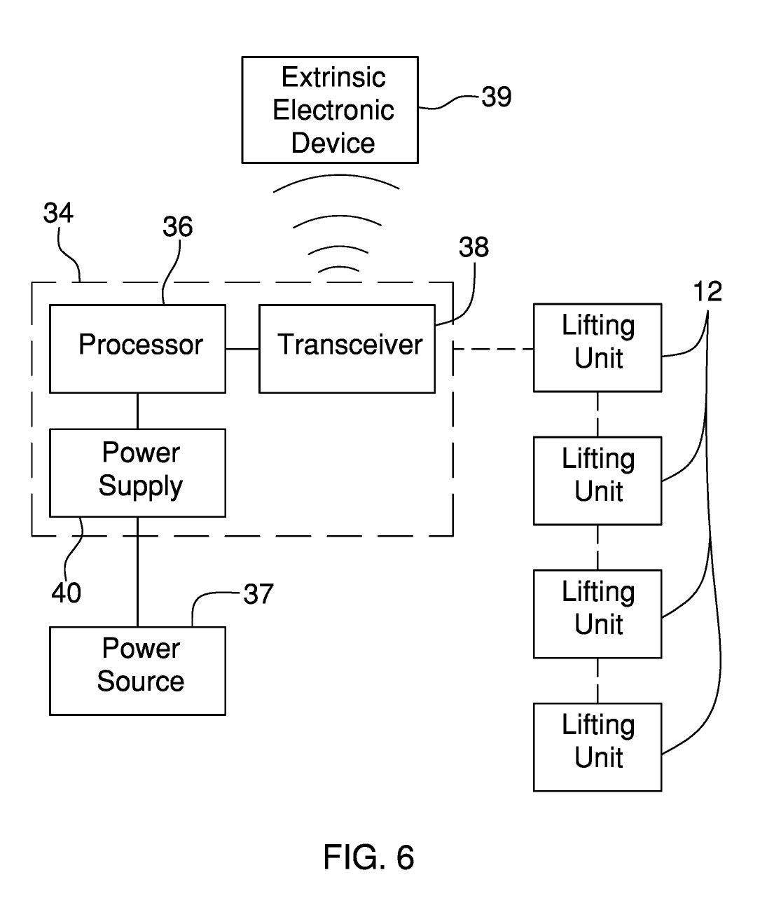

With reference now to the drawings, and in particular to FIGS. 1 through 6 thereof, a new fence device embodying the principles and concepts of an embodiment of the disclosure and generally designated by the reference numeral 10 will be described.

As best illustrated in FIGS. 1 through 6, the retractable fence assembly 10 generally comprises a plurality of lifting units 12. Each of the lifting units 12 may be sunk into a support surface 14. The support surface 14 may be ground. Each of the lifting units 12 is selectively positioned in a deployed position to extend upwardly from the support surface 14. Each of the lifting units 12 is selectively positioned in a stored position to be stored beneath the support surface 14. Each of the lifting units 12 is positioned to define an associated one of four corners of a rectangle.

Each of the lifting units 12 comprises a cylinder 16 that has an upper end 18 and a lower end 20. The upper end 18 is open and the cylinder 16 is substantially hollow. The cylinder 16 is vertically oriented within the support surface 14. Moreover, the upper end 18 is aligned with the support surface 14.

A bearing 22 is positioned in the cylinder 16. The bearing 22 is positioned on the lower end 20. A worm gear 24 is provided that has a first end 26 and a second end 28. The worm gear 24 is vertically oriented in the cylinder 16. The first end 26 is rotatably coupled to the bearing 22.

A motor 30 is provided. The motor 30 is coupled to the second end 28 of the worm gear 24. Thus, the motor 30 rotates the worm gear 24 when the motor 30 is turned on. The motor 30 rotates the worm gear 24 in a first direction and a second direction. The motor 30 may be an electric motor 30 or the like.

A shoe 32 is provided. The shoe 32 is coupled around the worm gear 24. The shoe 32 travels upwardly along the worm gear 24 when the motor 30 rotates the worm gear 24 in the first direction. The shoe 32 travels downwardly along the worm gear 24 when the motor 30 rotates the worm gear 24 in the second direction.

A control 34 is provided. The control 34 is in electrical communication with each of the lifting units 12. Thus, the control 34 controls operational parameters of each of the lifting units 12. The control 34 may include a housing that is remotely positioned with respect to each of the lifting units 12. A conductor may extend between the control 34 and each of the lifting units 12 and the conductor may be buried in ground. The housing may be coupled to an associated one of the lifting units 12. Each of the lifting units 12 may be in electrical communication with each other.

The control 34 comprises a processor 36 that is positioned within the control 34. The processor 36 is electrically coupled to the motor 30. The processor 36 selectively generates an up sequence such that the motor 30 rotates in the first direction. The processor 36 selectively generates a down sequence such that the motor 30 rotates in the second direction. The processor 36 may comprise an electronic processor 36 or the like.

A transceiver 38 is provided and the transceiver 38 is positioned within the control 34. The transceiver 38 is electrically coupled to the processor 36. The transceiver 38 may be in wireless communication with an extrinsic electronic device 39. The processor 36 generates the up sequence when the transceiver 38 receives an up command from the extrinsic electronic device 39. The processor 36 generates the down sequence when the transceiver 38 receives a down command from the extrinsic electronic device 39. The transceiver 38 may be a radio frequency transceiver 38 or the like. The extrinsic electronic device 39 may be a smart phone, a remote control 34 or other selectively manipulated extrinsic electronic device 39.

A power supply 40 is positioned within the control 34. The power supply 40 is electrically coupled to the processor 36. The power supply 40 is electrically coupled to a power source 37. The power supply 40 may be a conductor or the like. The power source 37 may be an electrical system of a house or the like.

A fencing unit 42 is provided. The fencing unit 42 is operationally coupled to each of the lifting units 12. Each of the lifting units 12 selectively positions the fencing unit 42 in the deployed position to surround an area. Each of the lifting units 12 selectively positions the fencing unit 42 in the stored position. Thus, the fencing unit 42 is positioned in a trench 41 in the support surface 14 to conceal the fencing unit 42. The area may be in a yard or the like.

The fencing unit 42 comprises a plurality of first posts 44. Each of the first posts 44 has a bottom end 43 and a top end 45. Each of the first posts 44 is vertically oriented in the cylinder 16 of an associated one of the lifting units 12. The bottom end 43 of each of the posts is coupled to the shoe 32 of an associated one of the lifting units 12. Each of the first posts 44 is urged to extend outwardly from the upper end 18 of the cylinder 16 of the associated lifting unit 12 when the motor 30 of the associated lifting unit 12 rotates in the first direction. Each of the first posts 44 is urged to be concealed within the cylinder 16 of the associated lifting unit 12 when the motor 30 of the associated lifting unit 12 rotates in the second direction.

A plurality of sleeves 46 is provided and each of the sleeves 46 has a topmost end 48 and a bottommost end 50. The topmost end 48 of each of the sleeves 46 is open and each of the sleeves 46 is substantially hollow. Each of the sleeves 46 is vertically oriented within the support surface 14 having the topmost end 48 being aligned with the support surface 14. Each of the sleeves 46 is centrally positioned between an associated pair of the corners of the rectangle.

A plurality of second posts 52 is provided. Each of the second posts 52 is slidably positioned within an associated one of the sleeves 46. Each of the second posts 52 has an uppermost end 54.

A plurality of fences 56 is provided. Each of the fences 56 is coupled between an associated one of the second posts 52 and an associated one of the first posts 44. Each of the fences 56 is positioned in a deployed position when the associated first post 44 is urged to extend outwardly from the associated cylinder 16. Thus, each of the fences 56 surrounds the area. Each of the fences 56 is positioned in a stored position when the associated first post 44 is urged to be concealed within the associated cylinder 16. Thus, each of the fences 56 is concealed in the trench 41.

Each of the fences 56 comprises a member 58. The member 58 is coupled between the top end 45 of the associated first post 44 and the uppermost end 54 of the associated second post 52. A panel 60 is coupled to and extends downwardly from the member 58. The panel 60 is slidably coupled between the associated first post 44 and the associated second post.

The panel 60 has a plurality of pleats 62. The pleats 62 are spaced apart from each other and are distributed downwardly from the member 58. The panel 60 extends upwardly from the support surface 14 when the each of the fencing units 42 is positioned in the deployed position. The panel 60 is folded into the trench when each of the fencing units 42 is positioned in the stored position. The panel 60 may be comprised of a mesh or the like.

In use, the extrinsic electronic device 39 is manipulated to actuate the processor 36 to generate the up sequence. Thus, fencing unit 42 is positioned in the deployed position to surround the area. The fencing unit 42 inhibits an animal or a child from leaving the area. The extrinsic electronic device 39 is manipulated to actuate the processor 36 to generate the down sequence. Thus, the fencing unit 42 is concealed in the trench 41. The fencing unit 42 facilitates a fence to be erected in a housing development that prohibits the use of permanent fencing or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A retractable fence assembly being configured to be selectively stored beneath support surface, said assembly comprising:
a plurality of lifting units, each of said lifting units being configured to be sunk into a support surface, each of said lifting units being selectively positioned in a deployed position wherein each of said lifting units is configured to extend upwardly from the support surface, each of said lifting units being selectively positioned in a stored position wherein each of said lifting units is configured to be stored beneath the support surface; and
a fencing unit being operationally coupled to each of said lifting units such that each of said lifting units selectively positions said fencing unit in said deployed position wherein said fencing unit is configured to surround an area, each of said lifting units selectively positioning said fencing unit in said stored position wherein said fencing unit is configured to be positioned in a trench in the support surface thereby facilitating said fencing unit to be concealed.

2. The assembly according to claim 1, wherein each of said lifting units comprises a cylinder having an upper end and a lower end, said upper end being open, said cylinder being substantially hollow, said cylinder being configured to be vertically oriented within the support surface having said upper end being aligned with the support surface.

3. The assembly according to claim 2, further comprising a bearing being positioned in said cylinder, said bearing being positioned on said lower end.

4. The assembly according to claim 3, further comprising a worm gear having a first end and a second end, said worm gear being vertically oriented in said cylinder, said first end being rotatably coupled to said bearing.

5. The assembly according to claim 4, further comprising a motor being coupled to said second end of said worm gear such that said motor rotates said worm gear when said motor is turned on, said motor rotating said worm gear in a first direction and a second direction.

6. The assembly according to claim 5, further comprising a shoe being coupled around said worm gear, said shoe travelling upwardly along said worm gear when said motor rotates said worm gear in said first direction, said shoe travelling downwardly along said worm gear when said motor rotates said worm gear in said second direction.

7. The assembly according to claim 1, further comprising a control being in electrical communication with each of said lifting units such that said control controls operational parameters of each of said lifting units.

8. The assembly according to claim 7, wherein:
a motor; and
said control comprises a processor being positioned within said control, said processor being electrically coupled to said motor, said processor selectively generating an up sequence such that said motor rotates in said first direction, said processor selectively generating a down sequence such that said motor rotates in said second direction.

9. The assembly according to claim 8, further comprising a transceiver being positioned within said control, said transceiver being electrically coupled to said processor, said transceiver being configured to be in wireless communication with an extrinsic electronic device, said processor generating said up sequence when said transceiver receives an up command from the extrinsic electronic device, said processor generating said down sequence when said transceiver receives a down command from the extrinsic electronic device.

10. The assembly according to claim 8, further comprising a power supply being positioned within said control, said power supply being electrically coupled to said processor, said power supply being configured to be electrically coupled to a power source.

11. The assembly according to claim 1, wherein:
each of said lifting units includes a cylinder, a shoe and a motor; and
said fencing unit comprises a plurality of first posts, each of said first posts having a bottom end and a top end, each of said first posts being vertically oriented in said cylinder of an associated one of said lifting units, said bottom end of each of said posts being coupled to said shoe of an associated one of said lifting units.

12. The assembly according to claim 11, wherein each of said first posts being urged to extend outwardly from said upper end of said cylinder of said associated lifting unit when said motor of said associated lifting unit rotates in a first direction, each of said first posts being urged to be concealed within said cylinder of said associated lifting unit when said motor of said associated lifting unit rotates in a second direction.

13. The assembly according to claim 1, further comprising:
each of said lifting units being positioned to define an associated one of four corners of a rectangle; and
a plurality of sleeves, each of said sleeves having a topmost end and a bottommost end, said topmost end of each of said sleeves being open, each of said sleeves being substantially hollow, each of said sleeves being configured to be vertically oriented within the support surface having said topmost end being aligned with the support surface, each of said sleeves being centrally positioned between an associated pair of said corners of said rectangle.

14. The assembly according to claim 13, further comprising a plurality of second posts, each of said second posts being slidably positioned within an associated one of said sleeves, each of said second posts having an uppermost end.

15. The assembly according to claim 14, further comprising:
a plurality of cylinders;
a plurality of first posts, each of said first posts selectively urged to extend outwardly from an associated one of said cylinders, each of said first posts being selectively urged to be concealed within said associated cylinder; and
a plurality of fences, each of said fences being coupled between an associated one of said second posts and an associated one of said first posts, each of said fences being positioned in a deployed position when said associated first post is urged to extend outwardly from said associated cylinder wherein each of said fences is configured to surround the area, each of said fences being positioned in a stored position when said associated first post is urged to be concealed within said associated cylinder wherein each of said fences is configured to be concealed in the trench.

16. The assembly according to claim 15, wherein each of said fences comprises a member being coupled between a top end of said associated first post and said uppermost end of said associated second post.

17. The assembly according to claim 16, further comprising a panel being coupled to and extending downwardly from said member, said panel being slidably coupled between said associated first post and said associated second post, said panel having a plurality of pleats, said pleats being spaced apart from each other and being distributed downwardly from said member, said panel extending upwardly from the support surface when said each of said fencing units is positioned in said deployed position, said panel being folded into the trench when each of said fencing units is positioned in said stored position.

18. A retractable fence assembly being configured to be selectively stored beneath support surface, said assembly comprising:
a plurality of lifting units, each of said lifting units being configured to be sunk into a support surface, each of said lifting units being selectively positioned in a deployed position wherein each of said lifting units is configured to extend upwardly from the support surface, each of said lifting units being selectively positioned in a stored position wherein each of said lifting units is configured to be stored beneath the support surface, each of said lifting units being positioned to define an associated one of four corners of a rectangle, each of said lifting units comprising:
a cylinder having an upper end and a lower end, said upper end being open, said cylinder being substantially hollow, said cylinder being configured to be vertically oriented within the support surface having said upper end being aligned with the support surface,
a bearing being positioned in said cylinder, said bearing being positioned on said lower end,
a worm gear having a first end and a second end, said worm gear being vertically oriented in said cylinder, said first end being rotatably coupled to said bearing,
a motor being coupled to said second end of said worm gear such that said motor rotates said worm gear when said motor is turned on, said motor rotating said worm gear in a first direction and a second direction,
a shoe being coupled around said worm gear, said shoe travelling upwardly along said worm gear when said motor rotates said worm gear in said first direction, said shoe travelling downwardly along said worm gear when said motor rotates said worm gear in said second direction;
a control being in electrical communication with each of said lifting units such that said control controls operational parameters of each of said lifting units, said control comprising:
a processor being positioned within said control, said processor being electrically coupled to said motor, said processor selectively generating an up sequence such that said motor rotates in said first direction, said processor selectively generating a down sequence such that said motor rotates in said second direction,
a transceiver being positioned within said control, said transceiver being electrically coupled to said processor, said transceiver being configured to be in wireless communication with an extrinsic electronic device, said processor generating said up sequence when said transceiver receives an up command from the extrinsic electronic device, said processor generating said down sequence when said transceiver receives a down command from the extrinsic electronic device, and
a power supply being positioned within said control, said power supply being electrically coupled to said processor, said power supply being configured to be electrically coupled to a power source; and
a fencing unit being operationally coupled to each of said lifting units such that each of said lifting units selectively positions said fencing unit in said deployed position wherein said fencing unit is configured to surround an area, each of said lifting units selectively positioning said fencing unit in said stored position wherein said fencing unit is configured to be positioned in a trench in the support surface thereby facilitating said fencing unit to be concealed, said fencing unit comprising:
a plurality of first posts, each of said first posts having a bottom end and a top end, each of said first posts being vertically oriented in said cylinder of an associated one of said lifting units, said bottom end of each of said posts being coupled to said shoe of an associated one of said lifting units, each of said first posts being urged to extend outwardly from said upper end of said cylinder of said associated lifting unit when said motor of said associated lifting unit rotates in said first direction, each of said first posts being urged to be concealed within said cylinder of said associated lifting unit when said motor of said associated lifting unit rotates in said second direction,
a plurality of sleeves, each of said sleeves having a topmost end and a bottommost end, said topmost end of each of said sleeves being open, each of said sleeves being substantially hollow, each of said sleeves being configured to be vertically oriented within the support surface having said topmost end being aligned with the support surface, each of said sleeves being centrally positioned between an associated pair of said corners of said rectangle,
a plurality of second posts, each of said second posts being slidably positioned within an associated one of said sleeves, each of said second posts having an uppermost end, and
a plurality of fences, each of said fences being coupled between an associated one of said second posts and an associated one of said first posts, each of said fences being positioned in a deployed position when said associated first post is urged to extend outwardly from said associated cylinder wherein each of said fences is configured to surround the area, each of said fences being positioned in a stored position when said associated first post is urged to be concealed within said associated cylinder wherein each of said fences is configured to be concealed in the trench, each of said fences comprising:
a member being coupled between said top end of said associated first post and said uppermost end of said associated second post, and
a panel being coupled to and extending downwardly from said member, said panel being slidably coupled between said associated first post and said associated second post, said panel having a plurality of pleats, said pleats being spaced apart from each other and being distributed downwardly from said member, said panel extending upwardly from the support surface when said each of said fencing units is positioned in said deployed position, said panel being folded into the trench when each of said fencing units is positioned in said stored position.
